(19) United States
(12) Patent Application Publication
(10) Pub. No.: US 2023/0388310 A1
(43) Pub. Date: Nov. 30, 2023

(54) SYSTEM AND METHOD FOR BIOMETRICALLY BINDING VERIFIABLE CREDENTIALS TO IDENTITY

(71) Applicant: TECH5 USA, Inc., Troy, MI (US)

(72) Inventors: Arthur Jack Girdwood-Naddell, Austin, TX (US); Gabriel Nimtzovitch Borger, Somerville, NJ (US)

(21) Appl. No.: 18/312,691

(22) Filed: May 5, 2023

Related U.S. Application Data
(60) Provisional application No. 63/347,539, filed on May 31, 2022.

(51) Int. Cl. H04L 9/40; G06Q 20/36

(52) U.S. Cl. CPC H04L 63/102; G06Q 20/363; H04L 63/0861

(57) ABSTRACT

The present disclosure provides a method for providing access to a restricted resource via use of biometrically verifiable credentials. The method includes creating, at a holder device, a blockchain wallet, the blockchain wallet being stored in a blockchain module, the blockchain module managing a blockchain. Creating, at the holder device, a holder user profile, the holder user profile being stored in the blockchain wallet. Receiving, at an issuer device, identification of a user; verifying, at the issuer device, the identification. Generating, at the issuer device, a biometric template, the biometric template being based on at least one biometric factor, the biometric factor being associated with the user. Sending, at the issuer device, the biometric template to the blockchain wallet.

### CROSS REFERENCE TO RELATED APPLICATION(S)

This application claims priority to U.S. Provisional Patent Application No. 63/347,539, filed on May 31, 2022 the contents of which are incorporated by reference herein in its entirety.

### FIELD

The present teachings provide a system and method to verify an identify of a user via biometrically binding and verifiable credentials.

### BACKGROUND

Biometric authentication is becoming more important as traditional methods of authentication are proving inadequate for modern requirements. Simple passwords, for example, are subject to attacks and can be easily compromised (e.g., by brute force password cracking methods). Additionally, users can forget passwords. Even when passwords are remembered, users can potentially divulge passwords (intentionally or inadvertently) such that an attacker may use the divulged password to access restricted resources.

Two-factor authentication (“2FA”) is a common solution to the vulnerabilities of simple passwords. Often, 2FA is implemented by using a primary device to access the restricted resource (e.g., a computer accessing a webpage). The primary device prompts the user for a password. Upon successful entry of the password, the user is then required to use a second factor. The second factor is often based on a one-time code that is sent via email or text to a user. In some solutions, an authentication application may provide a rolling, one-time code to the user. The one-time code is then used as a second factor to authenticate the user accessing the restricted resource.

However, simple passwords and 2FA fail to prove that the authorized user is in fact the authorized user. Thus, a nefarious user can impersonate the authorized user. If 2FA is involved, the same nefarious user can gain access to the one-time code. On the other hand, biometric-based authentication ensure that the user is who he or she claims to be since biometric factors are difficult to spoof. Further, multifactor biometric verification adds additional security to biometric-based authentication.

What is needed is a system and method for biometrically binding verifiable credentials to the identity of an authorized user.

### SUMMARY

The present disclosure provides a method for providing access to a restricted resource via use of biometrically verifiable credentials. The method includes creating, at a holder device, a blockchain wallet, the blockchain wallet being stored in a blockchain module, the blockchain module managing a blockchain. Creating, at the holder device, a holder user profile, the holder user profile being stored in the blockchain wallet. Receiving, at an issuer device, identification of a user; verifying, at the issuer device, the identification. Generating, at the issuer device, a biometric template, the biometric template being based on at least one biometric factor, the biometric factor being associated with the user. Sending, at the issuer device, the biometric template to the blockchain wallet.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 illustrates a block diagram of an authentication system configured to provide access to a restricted resource.

FIG. 2A illustrates a block diagram of a holder device.

FIG. 2B illustrates a block diagram of an issuer device.

FIG. 3 is a flowchart illustrating a process for binding a biometric template to a user.

FIG. 4 is a flow chart illustrating a process for biometrically binding verifiable credentials to a user.

FIG. 5 is a flowchart illustrating a process for using verifiable credentials to access a restricted resource.

FIG. 6 is a block diagram illustrating an example wireless communication device suitable for use with the various aspects described herein.

FIG. 7 is a block diagram illustrating an example computing device suitable for use with the various aspects described herein.

FIG. 8 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In the world today, people cannot simply access any area that they choose. For example, a bank customer may not access the area behind the counter where the bank tellers control the currency. At airports, passengers are not allowed in restricted areas of the airport (e.g., near dangerous equipment). In the digital world, resources may be permissioned. For example, a cloud service may host a number of credit card numbers associated with customers. However, the cloud service will restrict a first customer from accessing the credit card numbers associated with the other customers, i.e., the first customer only has permission to her own credit card numbers. Any such types of resources, whether physical or digital, shall be referred to as restricted resources throughout this disclosure.

Restricted resources may be protected by physical security services. For example, keyed locks may be placed on a door to a baseball field. As another example, a human guard may check identification prior to allowing a person to pass through a checkpoint. In the digital arts, a server may require a password to access a restricted resource (e.g., a bank account login). For the digital arts, 2FA may be utilized to enhance secure access to the restricted resource. Whether means are physical or digital, the restricted resource is accessible by a user in control of a key and/or password. However, existing authentication systems have no means by which to determine that the key and/or password are being used by the user who was originally issued the key and/or password.

The disclosed solution provides a system and method by which an authentication system may issue verifiable credentials to a user that are bound to the biometric features of the user.

Many users today would like to be in control of their own credentials, including carrying said credentials in their own secure, blockchain-based wallet. Enterprises welcome such a change, in part, because the trend reduces the burden on enterprises to store sensitive data (including user passwords). However, the user is now burdened with providing credentials upon which the enterprise may rely as being valid. The disclosed solution provides for using biometric-based authentication to ensure credentials are only usable by the user to whom the credentials were issued. In other words, if credentials are issued to Sally and Dan later tries to use said credentials, the disclosed solution would prevent Dan from accessing a restricted resource.

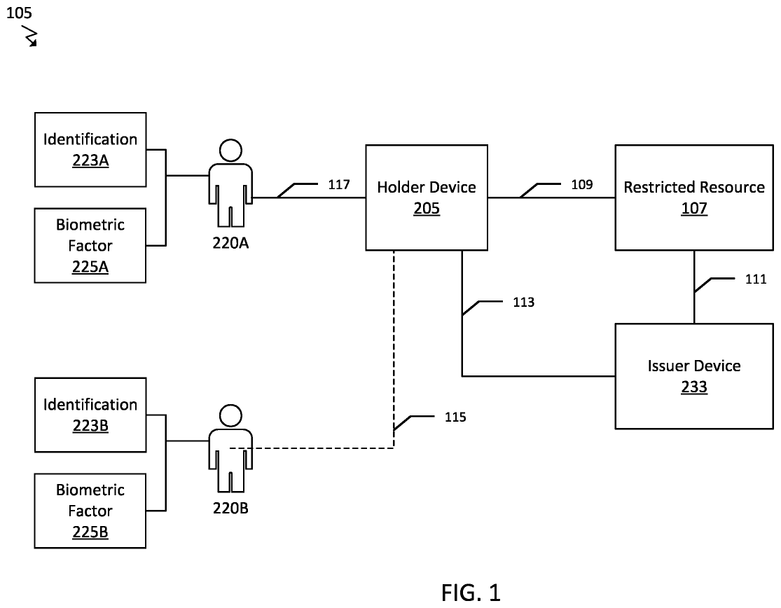

FIG. 1 illustrates a block diagram of an authentication system 105 configured to provide access to a restricted resource 107. The authentication system 105 comprises a first user 220A, a second user 220B, a holder device 205, the restricted resource 107, an issuer device 233, a first link 117, a second link 115, a third link 113, a fourth link 109, and a fifth link 111.

The user 220A is a human user of the holder device 205 as shown by the link 117. For example, the user 220A may be a student, and the holder device 205 may be an Apple® iPad. Further, the link 117 may be the user 220A interacting via a touchscreen display.

The user 220B is also a human user with a key distinction; the user 220B is not authorized to access the credentials on the holder device 205. The dotted line of the link 115 indicates the unauthorized access to the holder device 205. One of skill in the art will appreciate that the link 115 may be the physical operation of the holder device 205 (e.g., the user 220B has stolen the holder device 205 and is trying to access the credentials stored therein). In another aspect, the link 115 may be a digital hack into the holder device 205 (e.g., as a brute force password attack).

The user 220A is associated with an identification 223A and a biometric factor 225A. Similarly, the user 220B is associated with an identification 223B and a biometric factor 225B. The identifications 223A, 223B may be government-issued identification in one aspect (e.g., a passport). The biometric factors 225A, 225B are generally capable of uniquely identifying the users 220A, 220B, respectively. Examples of biometric factors 225A, 225B include eyes, fingerprint, scars, voice, markings, skin color, height, face, palm, etc.

The holder device 205 is generally configured to store credentials for the user 220A. The user 220A may gain access to the restricted resource 107 via the link 109. For example, the holder device 205 may be an Android® smartphone, and the restricted resource 107 may be a security door to an office building. In general, the link 109 is wireless but may be wired in some implementations. For example, the link 109 may be a near-field communication-based signal.

The issuer device 233 is generally configured to issue credentials to the holder device

205. For example, the issuer device 233 may issue private keys to access a public-key based Unix login. The issuer device 233 is in communication with the restricted resource 107, via the link 111. The link 111 may be an IP-based network, in one aspect. The holder device 205 may communicate via the link 113 in order to request and be issued credentials. The link 113 may be an IP-based network, in one aspect.

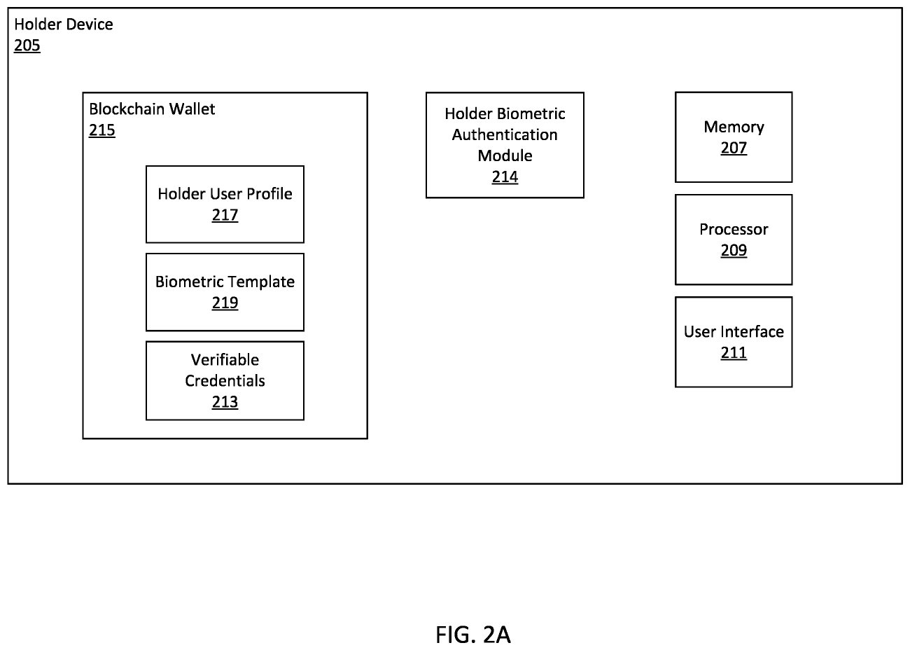

FIG. 2A illustrates a block diagram of a holder device 205. The holder device 205 comprises a blockchain wallet 215, a holder biometric authentication module 214, a memory 207, a processor, and a user interface 211.

The blockchain wallet 215 comprises a holder user profile 217, a biometric template 219, and verifiable credentials 213. The holder user profile 217 is generally configured to store information associated with the user 220A. Examples of such information include name, age, height, weight, address, government-issued identification number, phone number, email, etc.

The biometric template 219 is generally configured to biometrically describe the biometric factor 225A. For example, the biometric template 219 may be based on the biometric factor 225A of green eye color. In one aspect, the biometric template 219 is multimodal viz. the biometric template relates to more than one biometric factor. For example, the biometric template 219 is based on both green eye color and brown hair color.

The verifiable credentials 213 are generally configured to provide access to the restricted resource 107. For example, the verifiable credential 213 may be a transit pass required to board a train. One benefit of the authentication system 105 is that the transit pass may be bound to the identity of the user 220A via the biometric template 219.

The holder biometric authentication module 214 is generally configured to provide biometric-related operations for the holder device 205. For example, the holder biometric authentication module 214 may be configured to provide face identification to biometrically control access to the verifiable credential 213.

The processor 209 may be a general-purpose processor, an application specific

integrated circuit (“ASIC”), a fully programable gate array, etc. The memory 207 may be volatile, non-volatile or a combination thereof. The user interface 211 may be a software program executing on the processor 209 and being stored in the memory 207. In one aspect, the user interface 211 may be a graphical user interface operating on a touchscreen display. In another aspect, a computing device using a mouse and a keyboard may be utilized as the user interface 211.

FIG. 2B illustrates a block diagram of an issuer device 233. The issuer device 233 comprises a blockchain module 243, an issuer biometric authentication module 242, a credential module 245, a memory 235, a processor 237, and a user interface 239.

The blockchain module 243 is generally configured to provide a blockchain. The blockchain may be private or public. For example, the blockchain module 243 may be in communication with the Ethereum public blockchain. The blockchain module 243 is generally configured to provide a non-custodial wallet for a device. For example, the blockchain wallet 215 may be stored in the Ethereum public blockchain as a record.

The issuer biometric authentication module 242 is generally configured to provide authentication of biometric templates. In one aspect, the issuer biometric authentication module 242 is in communication with the holder biometric authentication module 214 such that the authentication modules 214, 242 may share logic, algorithms, data, etc. in order to authenticate the user 220A and provide verifiable credentials 213 (via the credentials module 245). In one aspect, the issuer biometric authentication module 242 may be configured to provide multimodal biometric authentication.

The credential module 245 is generally configured to issue the verifiable credentials 213 to the holder device 205. The credential module 245 may manage and store digital credentials related to access to the restricted resource 107. The verifiable credentials 213 may be used for physical access systems. For example, the verifiable credentials 213 may be used at a bank vault door in order to gain access to the bank vault, i.e., physical access to the bank vault (as the restricted resource 107). Likewise, the verifiable credentials 213 may provide electronic (i.e., digital) access to the restricted resource 107. For example, the verifiable credentials 213 may be used to access tax records (as the restricted resource 107) belonging to a client of a tax preparation service, i.e., digital/electronic access via the verifiable credentials 213.

The processor 237 may be a general-purpose processor, an application specific

integrated circuit (“ASIC”), a fully programable gate array, etc. The memory 235 may be volatile, non-volatile or a combination thereof. The user interface 239 may be a software program executing on the processor 237 and being stored in the memory 235. In one aspect, the user interface 239 may be a graphical user interface operating on a touchscreen display. In another aspect, a computing device using a mouse and a keyboard may be utilized as the user interface 239.

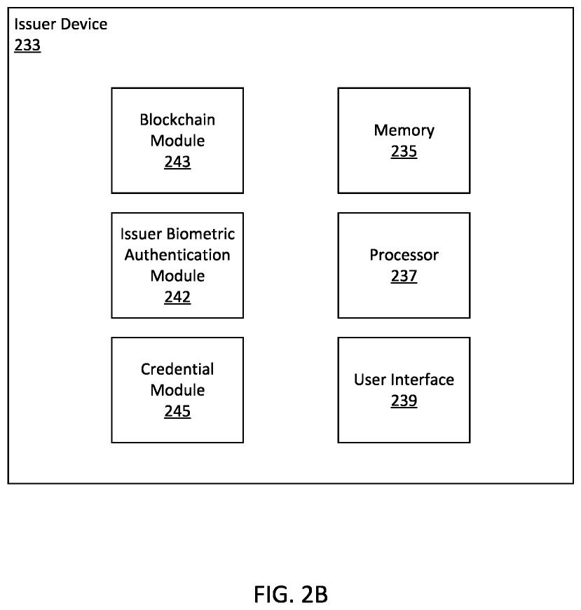

FIG. 3 is a flowchart illustrating a process 301 for binding the biometric template 219 to the user 220A. The process 301 begins at the start block 302 and proceeds to the block 303. At the block 303, the process 301 receives input from the user 220A to indicate that the blockchain wallet 215 be created at the blockchain module 243. The block 303 is denoted in dotted lines to indicate the optionality of the operation because the user 220A may have already created (prior to the process 301) a blockchain wallet at the blockchain module 243. Whether newly created or previously created, the user 220A requires access to the blockchain wallet 215 as part of the solution disclosed herein. The blockchain wallet 215 may, in one aspect, be non-custodial. The process 301 then proceeds to the block 305.

At the block 305, the process 301 receives input from the user 220A to create the holder user profile 217 at the holder biometric authentication module 214. For example, the user interface 211 may be a touchscreen configured to accept identifying information such as government identification number, address, birthdate, legal name, etc. The process 301 then proceeds to the block 307.

At the block 307, the process 301 receives input indicating that the user 220A is presenting identification that is substantially consistent with the holder user profile 217. In one aspect, the presentation of the identification 233A may be performed with a human actor operating the issuer device 233. For example, a security guard at an airport may physically inspect the identification 233A (e.g., a passport) prior to interacting with the user interface 239 to accept the identification 233A as valid for the user 220A presenting said identification 233A. In another aspect, the presentation may be performed electronically. For example, the user 220A may present the identification 233A via a webcam that is managed by the issuer device 233.

One of skill in the art will appreciate that the issuer device 233 may comprise automation rules that are unique to the operating environment of the issuer device 233. For example, the issuer device 233 may have automation rules that define when a match between the identification 233A and the holder user profile 217 exists. Such a match may have a predetermined confidence requirement (e.g., 95% confidence) that automatically uses biometrics to determine the confidence of the match. As such, access to a military base may require 99% confidence whereas access to a baseball game may only require 90% confidence. The process 301 then proceeds to the block 309.

At the block 309, the process 301 causes the issue biometric authentication module 214 to issue the biometric template 219 to the holder device 205. In one aspect, the biometric template 219 is generated based on biometric data captured at the holder device 205. In another aspect, the biometric template 219 is generated based on biometric data captured at the issuer device 233. After capturing the biometric data, the biometric template 219 is associated with the user 220A and stored in the blockchain wallet 215. One of skill in the art will appreciate that the biometric template 219, when properly created, is only valid for the user 220A. The process 301 then proceeds to the end block 311 and terminates.

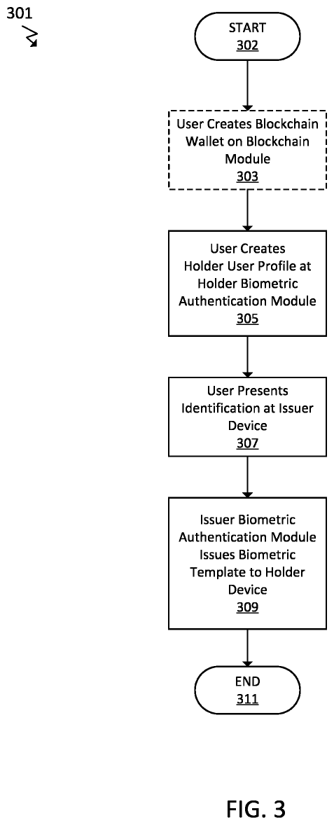

FIG. 4 is a flowchart illustrating a process 401 for biometrically binding the verifiable credentials 213 to the user 220A. The process 401 begins at the start block 402 and proceeds to the block 405. At the block 405, the process 401 receives a request from the issuer device 233 and/or the holder device 205 to request the verifiable credential 213 be issued from the issuer device 233. The verifiable credentials 213 may be stored in the blockchain wallet 215. In one aspect, the user 220A may operate the holder device 205 to request access to the restricted resource 107. For example, the user 220A may enter a bank and request access to a bank account (as the restricted resource 107) using the user interface 211. The process 401 then proceeds to the block 407.

At the block 407, the process 401 verifies, at the issuer device 233, the user 220A based on the biometric template 219. The user 220A may present the identification 223A in order to prove that the user 220A is in fact the user 220A. In one aspect, the user 220A may physically present the identification 223A to a human operator at the issuer device 233. In another aspect, the user 220A may present the identification 233A with the assistance of the holder device 205 and/or the issuer device 233. The process 401 then proceeds to the block 409.

At the block 409, the process 401 creates, at the issuer device 233, the verifiable credentials 213. The verifiable credentials 213 are cryptographically bound to the biometric template 219. The process 401 then proceeds to the block 411.

At the block 411, the process 401 sends the verifiable credentials 213 from the issuer device 233 to the blockchain wallet 215. One of skill in the art will appreciate that the sending may be performed by the issuer device 233 sending, via the blockchain module 243, the verifiable credentials 213 to the blockchain wallet 215. The process 401 then proceeds to the block 413.

At the block 413, the process 401 accepts, at the holder device 205, the verifiable credentials 213 for storage in the blockchain wallet 215. As shown in dotted lines, the user 220A may accept the verifiable credentials 213. However, given the nature of blockchain technology, the verifiable credentials 213 may not require acceptance, thus the verifiable credentials 213 may be sent without an acceptance event by the user 220A (and/or the holder device 205). The process 401 then proceeds to the end block 421 and terminates.

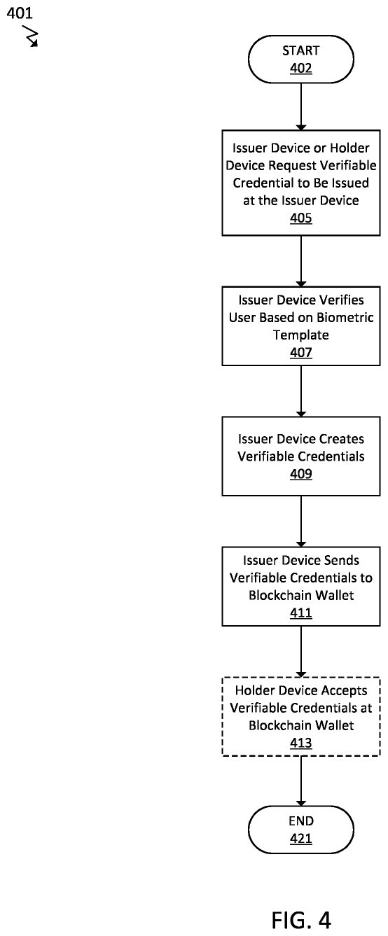

FIG. 5 is a flowchart illustrating a process 501 for using the verifiable credentials 213 to access the restricted resource 107. The process 501 begins at the start block 503 and proceeds to the block 505. At the block 505, the process 501 requests, at the holder device 205, access to the restricted resource 107. In one aspect, the user 220A may operate the holder device 205 in order to gain access to the restricted resource 107. For example, the user 220A may desire access to an airport kiosk containing an airplane ticket belonging to the user 220A. The holder device 205 may send a request via the IP protocol to the kiosk. As another example, the holder device 205 may communicate with a Bluetooth enabled device such as the power locks to an automobile.

The process 501 then proceeds to the block 507.

At the block 507, the process 501 prompts, at the holder device 205, the user 220A for verification of the biometric template 219. The user 220A presents the same biometric factor as captured by the biometric template 219. For example, if the user 220A provided facial features during the process 301, then the biometric template 219 will require a facial image of the user 220A in order to use the verifiable credentials 213. As such, the user 220A may be prompted by the holder device 205 to pose for a facial image capture via camera. The process 501 then proceeds to the decision block 511.

At the decision block 511, the process 501 determines whether a match exists between the biometric template 219 and the verifiable credentials 213. The match may be multimodal in one aspect. For example, the match may be based on one or more biometric factors (e.g., face, iris, and fingerprint). If a match does not exist, the process 501 proceeds along the NO branch to the end block 521 and terminates. Returning to the decision block 511, if a match does exist, the process 501 proceeds along the YES branch to the block 513.

At the block 513, the process 501 grants access, at the holder device 205, to the restricted resource 107. For example, the user 220A may desire access to an email account. Upon a successful match at the decision block 511, the holder device 205 may gain access to the email account (as the restricted resource 107). The process then proceeds to the end block 521 and terminates.

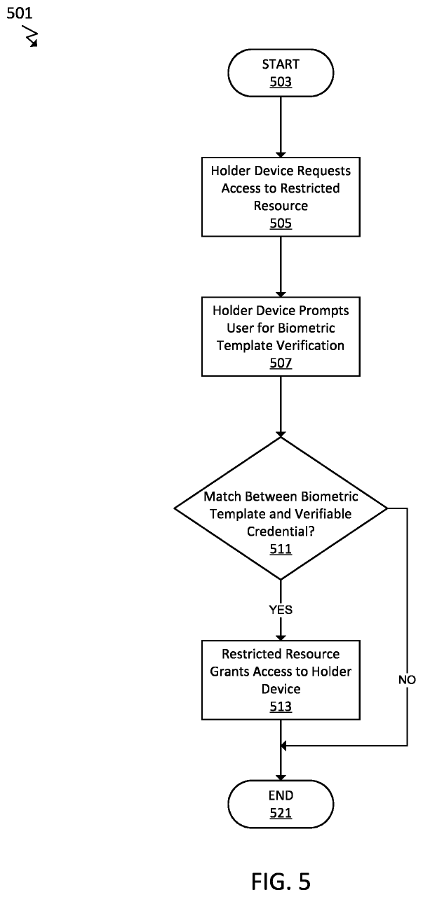

FIG. 6 is a block diagram illustrating a mobile communication device 600 suitable for use with the various aspects described above. Specifically, the mobile communication device 600 may be utilized to implement the processes 301, 401, 501. Further, the mobile communication device 600 may be utilized as the holder device 205 and/or the issuer device 233. The mobile computing device 600 may include a processor 602 coupled to a touchscreen controller 604 and an internal memory 606. The processor 602 may be one or more multicore integrated circuits designated for general or specific processing tasks. The internal memory 606 may be volatile or non-volatile memory and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the computing device 600 need not have touch screen capability.

The mobile computing device 600 may have one or more radio signal transceivers 608 (e.g., WIFI, LTE, etc.) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile computing device 600 may include a wireless modem device 616 thus enabling communication via a wireless network.

The mobile computing device 600 may include a peripheral device connection interface 618 coupled to the processor 602. The peripheral device connection interface 618 may be singularly configured to accept one type of connection, or may be configured to accept various types of physical and communication connections, common or proprietary, such as Universal Serial Bus (“USB”), FireWire, Thunderbolt, PCIe, Lightning, etc. The peripheral device connection interface 618 may also be coupled to a similarly configured peripheral device connection port (not shown). In one aspect, the peripheral device connection interface 618 may utilize wireless technology (e.g., Bluetooth) to communicate with devices.

The mobile computing device 600 may also include a speaker 614 for providing audio outputs. The mobile computing device 600 may also include a housing 620, constructed of a plastic, metal, or a combination of materials, for containing all or some of the components described herein. The mobile computing device 600 may include a power source 622 coupled to the processor 602, such as a disposable or rechargeable battery. The rechargeable battery may also be coupled to the peripheral device connection interface 618 to receive a charging current from a source external to the mobile computing device 600. In one aspect, the mobile computing device 600 may receive charging current via a wireless interface (e.g., Qi). The mobile computing device 600 may also include a physical button 624 for receiving user inputs. The mobile computing device 600 may also include a power button 626 for turning the mobile computing device 600 on and off.

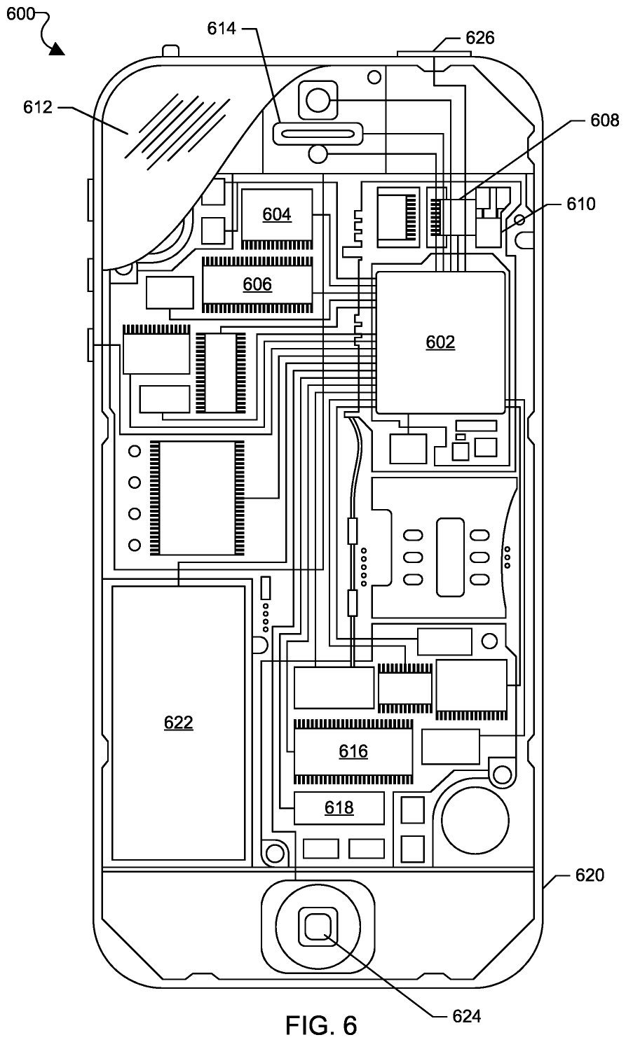

FIG. 7 is a block diagram illustrating a computing device 700 suitable for use with the various aspects described herein. Specifically, the computing device 700 may be utilized to implement the processes 301, 401, 501. Further, the computing device 700 may be utilized as the holder device 205 and/or the issuer device 233. The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711. The computing device 700 may include a touchpad touch surface 717 that serves as the computing device's 700 pointing device, and thus may receive drag, scroll, flick etc. gestures similar to those implemented on computing devices equipped with a touch screen display as described above. In one aspect, the touch surface 717 may be integrated into one of the computing device's 700 components (e.g., the display). In one aspect, the computing device 700 may include a keyboard 718 which is operable to accept user input via one or more keys within the keyboard 718. In one configuration, the computing device's 700 housing includes the touchpad 717, the keyboard 718, and the display 719 all coupled to the processor 711. Other configurations of the computing device 700 may include a computer mouse coupled to the processor (e.g., via a USB input) as are well known, which may also be used in conjunction with the various aspects described herein.

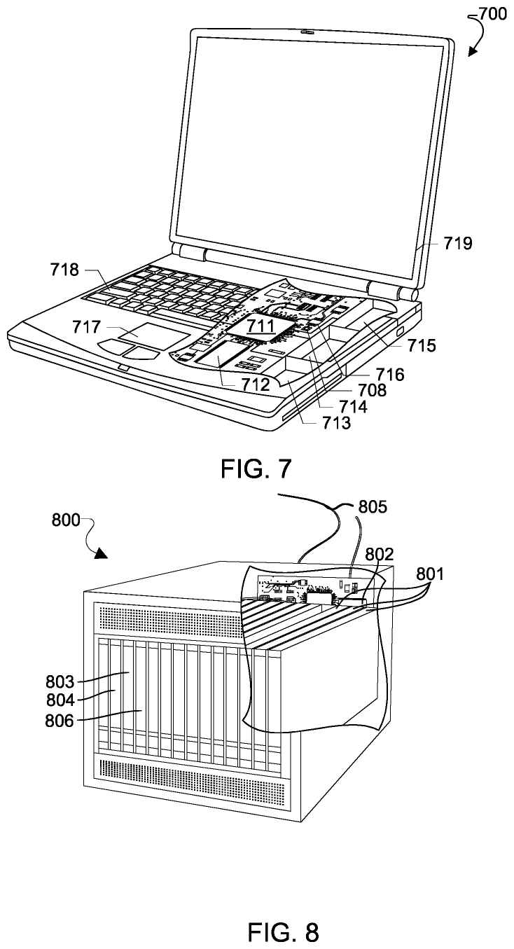

FIG. 8 is a block diagram illustrating a server 800 suitable for use with the various aspects described herein. Specifically, the server 800 may be utilized to implement the processes 301, 401, 501. Further, the server 800 may be utilized as the holder device 205 and/or the issuer device 233. The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by insertion into the racks of the assembly. The server 800 may also include an optical drive 806 coupled to the processor 801.

The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order.

Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality.

Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration.

Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk

storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

What is claimed is:

1. A method for providing access to a restricted resource via use of biometrically verifiable credentials, the method comprising:
creating, at a holder device, a blockchain wallet, the blockchain wallet being stored in a blockchain module, the blockchain module managing a blockchain;
creating, at the holder device, a holder user profile, the holder user profile being stored in the blockchain wallet;
receiving, at an issuer device, identification of a user;
verifying, at the issuer device, the identification;
generating, at the issuer device, a biometric template, the biometric template being based on at least one biometric factor, the biometric factor being associated with the user; and
sending, at the issuer device, the biometric template to the blockchain wallet.

2. The method of claim 1, the method further comprising:
requesting, at the holder device, verifiable credentials to be issued from the issuer
device; generating, based on the biometric template, verifiable credentials, the verifiable
credentials being generated if a first match exists between the biometric template and the user of the holder device;
creating, at the issuer device, verifiable credentials; and
sending, at the issuer device, verifiable credentials to the blockchain wallet.

3. The method of claim 2, the method further comprising:
requesting, at the holder device, access to the restricted resource;
prompting, at the holder device, the user to provide the biometric factor;
determining, at the holder device, a second match exists between the biometric template and the biometric factor; and
providing, at the restricted resource, access to the restricted resource, the access being provided to the holder device based on the second match existing.

4. The method of claim 3, wherein the biometric template is based on the group consisting of: face, iris, skin color, fingerprint, palm, scars, markings, hair color, height, weight, behavior, and voice.

5. The method of claim 3, wherein the issuer device is selected from the group consisting of: a kiosk, a computer having a camera, and a smartphone.

6. The method of claim 3, wherein the holder device is selected from the group consisting of: a smartphone and a computer.

7. The method of claim 3, wherein the restricted resource is selected from the group consisting of: a bank account, an email account, a file system, and a travel ticket.

8. A plurality of instructions stored in a memory and configured to cause a computer to execute the method of claim 1.

9. A computing device configured to execute the steps of the method of claim 1.
